(19) United States
(12) Patent Application Publication
(10) Pub. No.: US 2008/0220035 A1
(43) Pub. Date: Sep. 11, 2008

(54) Training spray

(76) Inventor: Erwin del Pinal, Albany, CA (US)

Correspondence Address: Degosits & Noah LLP, Suite 1450, Four Embarcadero Center, San Francisco, CA, 94111, US

(21) Appl. No.: 11/716,500

(22) Filed: Mar. 9, 2007

(51) Int. Cl. A01N 25/02; A01N 25/16; A01N 65/00; A01P 17/00

(52) U.S. Cl. 424/405; 424/736

(57) ABSTRACT

A composition for deterring a domestic pet from intruding upon a designated area. The composition includes a citrus oil, foaming and wetting agents in an aqueous carrier. The composition is particularly effective when applied in the form of a mist or spray deterring a cat from scratching furniture or related items.

### TECHNICAL FIELD

A composition for deterring a domestic pet from intruding upon a designated area. The composition includes a citrus oil, foaming and wetting agents in an aqueous carrier. The composition is particularly effective when applied in the form of a mist or spray deterring a cat from scratching furniture or related items.

### BACKGROUND OF THE INVENTION

Pet owners have constantly searched for training aides to alter pet tendencies without resorting to corporal punishment.

Training a domestic pet can be particularly problematic when one attempts to alter instinctive behavior. For example, cats instinctively need to scratch and although cat scratchers can be provided for this purpose, unless trained, the typical cat will tend to scratch any suitable surface such as the sides of upholstered furniture or hanging draperies causing extensive damage. To deter this activity, the pet owner must observe the to be prevented scratching activity as it takes place while redirecting the cat to a suitable scratching surface. Oftentimes, however, a pet owner observes the damage after it has occurred and, at that point, punishing or otherwise redirecting the cat will not prove beneficial.

Even if a pet owner was to catch a cat in the act of scratching furniture, pulling the cat away from the furniture and scolding it can oftentimes prove confusing for, as noted above, such activity is instinctive to the cat and confusion reigns as the cat believes that it is being punished for something that is part of its general nature.

Besides scratching, a pet owner oftentimes will seek to modify a pet's behavior in order to enable the pet to integrate into a particular living environment. For example, a pet owner may wish to prevent a pet from climbing or jumping upon furniture or would like to prevent the pet from entering into a certain portion of one's living space as being off limits to the pet. Again, training a pet to avoid certain activities is a difficult task particularly if the pet owner has a busy schedule and is thus not constantly interfacing with the pet as the frowned-upon activity takes place.

It is thus an object of the present invention to provide a composition which is non-toxic, non-abrasive and pleasant to use and yet can be employed as a behavioral modifying training aide.

This and further objects will be more readily apparent when considering the following disclosure and appended claims.

### SUMMARY OF THE INVENTION

A composition for deterring a domestic pet from intruding upon or degrading a designated area, said composition comprising a citrus oil, foaming and wetting agents in an aqueous carrier.

### DETAILED DESCRIPTION OF THE INVENTION

As noted previously, the present invention is directed to a composition and a method of employing this composition as a training aide and as a means of preventing a domestic pet, such as a domestic cat, from engaging in unauthorized scratching and similar frowned-upon activities. A necessary requirement for this composition is that it not be injurious to a pet or to a toddler who may instinctively place a treated object in his or her mouth while still possess the necessary deterrent effect. The composition further cannot be of the kind to emanate noxious odors or be otherwise unpleasant to deal with on a day-to-day basis.

It has been found that the sought after characteristics are achieved by providing a composition broadly described as comprising a citrus oil, such as lemon oil, foaming and wetting agents in an aqueous carrier. It has been found specifically that lemon oil has a unique deterrent effect that pets and specifically domestic cats respond to.

It has been found that the aqueous composition should contain at least 0.2% (wt.) of the citrus oil, such as lemon oil to be effective. Ideally, the composition should have approximately 1.0% (wt.) of this citrus oil in combination with other ingredients, the majority ingredient being the aqueous carrier, ideally water.

The foaming and wetting agents comprise a member selected from the group consisting of eucalyptus oil, polyethylene glycol, glycerol cocoate, polypropylene glycol, castor oil and mixtures thereof. The ideal composition comprises approximately 0.2% (wt.) eucalyptus oil, approximately 1.0% (wt.) PEG-7 glycerol cocoate, approximately 1.0% (wt.) lemon oil, approximately 3.0% (wt.) of a mixture of PPG, PEG and castor oil and approximately 94.8% (wt.) water.

The composition recited above is best applied by placing it within a spray bottle and spraying a light mist over a surface that one wishes to remain off limits to a pet. For example, the sides of an upholstered sofa could be lightly sprayed with this composition. It has been found that, upon doing so, cats will refrain from approaching this surface and will certainly not engage in unwanted scratching activity as long as the composition continues to exhibit its deterrent effect. Depending upon the porosity of the receiving surface and other environmental conditions such as relative humidity and temperature, multiple applications of this composition are oftentimes needed over time to maintain its efficacy.

In employing the present composition, one need not concern oneself with engaging in corporal punishment which can result in alienating a pet from its owner. An owner further need not concern him or herself with observing frowned upon activity first hand which is clearly necessary in engaging in behavioral modification. On the contrary, one need only apply the present composition as needed to ensure the deterrent effect.

What is claimed is:

1. A composition for deterring a domestic pet from intruding upon a designated area, said composition comprising a citrus oil, foaming and wetting agents in an aqueous carrier.

2. The composition of claim 1 wherein said citrus oil comprises lemon oil in an amount of at least approximately 0.2% (wt.) based upon the weight of the entire composition.

3. The composition of claim 1 wherein said foaming and wetting agents comprise a member selected from the group consisting of eucalyptus oil, polyethylene glycol, glycerol cocoate, polypropylene glycol, castor oil and mixtures thereof.

4. The composition of claim 1 wherein said aqueous carrier comprises water.

5. A composition for deterring a domestic pet from intruding upon a designated area comprising approximately 0.2% (wt.) eucalyptus oil, approximately 1.0% (wt.) PEG-7 glycerol cocoate, approximately 1.0% (wt.) lemon oil, approximately 3.0% (wt.) of a mixture of PPG, PEG and castor oil and approximately 94.8% (wt.) water.

6. A method of deterring a domestic pet from intruding upon a designated area comprising applying to said designated area a composition comprising a citrus oil, foaming and wetting agents in an aqueous carrier.

7. The method of claim 6 wherein said composition is applied by spraying it as a mist only on said designated area.

8. The method of claim 6 wherein citrus oil comprises lemon oil in an amount of at least approximately 0.2% (wt.) based upon the weight of the entire composition.

9. The method of claim 6 wherein said foaming and wetting agents comprise a member selected from the group consisting of eucalyptus oil, polyethylene glycol, glycerol cocoate, polypropylene glycol, castor oil and mixtures thereof.

10. The method of claim 6 wherein said aqueous carrier comprises water.

11. The method of claim 6 wherein said composition comprises approximately 0.2% (wt.) eucalyptus oil, approximately 1.0% (wt.) PEG-7 glycerol cocoate, approximately 1.0% (wt.) lemon oil, approximately 3.0% (wt.) of a mixture of PPG, PEG and castor oil and approximately 94.8% (wt.) water.

12. A method of deterring a domestic cat from scratching a surface comprising applying to said surface a composition comprising a citrus oil, foaming and wetting agents and an aqueous carrier.

13. The method of claim 12 wherein said composition is applied by spraying it as a mist only on said surface.

14. The method of claim 12 wherein citrus oil comprises lemon oil in an amount of at least approximately 0.2% (wt.) based upon the weight of the entire composition.

15. The method of claim 12 wherein said foaming and wetting agents comprise a member selected from the group consisting of eucalyptus oil, polyethylene glycol, glycerol cocoate, polypropylene glycol, castor oil and mixtures thereof.

16. The method of claim 12 wherein said aqueous carrier comprises water.

17. The method of claim 12 wherein said composition comprises approximately 0.2% (wt.) eucalyptus oil, approximately 1.0% (wt.) PEG-7 glycerol cocoate, approximately 1.0% (wt.) lemon oil, approximately 3.0% (wt.) of a mixture of PPG, PEG and castor oil and approximately 94.8% (wt.) water.
